(19) United States
(12) Patent Application Publication
(10) Pub. No.: US 2002/0088071 A1
(43) Pub. Date: Jul. 11, 2002

(54) Reusable paintbrush handle

(76) Inventor: Robert S. Nouis, Pasadena, TX (US)

Correspondence Address: PAUL S MADAN, MADAN, MOSSMAN & SRIRAM, PC, 2603 AUGUSTA, SUITE 700, HOUSTON, TX, 77057-1130, US

(21) Appl. No.: 10/042,583

(22) Filed: Jan. 9, 2002

Related U.S. Application Data
(60) Provisional application No. 60/260,899, filed on Jan. 11, 2001.

(51) Int. Cl. A46B 7/04; B25G 3/30; B05D 1/28

(52) U.S. Cl. 15/145; 15/176.2; 427/256; 427/429

(57) ABSTRACT

A paintbrush handle is claimed which is made of a durable material which can be reused for long periods of time allowing artisans using the paintbrush handles to avoid the problems associated with relearning a paintbrush handle after having had to discard a paintbrush of conventional manufacture. Also claimed is a process for striping cars.

### REFERENCE TO RELATED APPLICATION

This application claims priority from U.S. Provisional Patent Application Serial No. 60/260,899, filed Jan. 11, 2001.

### BACKGROUND OF THE INVENTION

1. Field of the Invention

The present invention relates to a paintbrush handle and method of using same.

The present invention particularly relates to a reusable paintbrush handle and method of using same.

2. Background of the Art

It is known in the art of painting to use brushes having detachable handles. For example, U.S. Pat. No. 4,471,507 to Schwartz, discloses a paintbrush that allows for the use of a handle with a plurality of ferrules containing fibers. It is also known to use many different means of attaching such tips to such paintbrush handles. For example, U.S. Pat. No. 5,435,037 to Ledingham and U.S. Pat. No. 6,035,481 to Douglas, et al., disclose paintbrushes with different means for attaching bristle packs.

It is also recognized in the art of painting to use brushes specialized for drawing fine lines. For example, U.S. Pat. No. 5,220,702 to Howell, et al., discloses a paintbrush with a central core of stiff fibers such as badger or horse hair, surrounded by sable hair.

It would be desirable in the art of using paintbrushes for drawing long fine lines to use a paintbrush having a handle which is long lasting and does not require frequent relearning of a new paintbrush handles. It would be especially desirable in the art of automobile striping to use a paintbrush having a handle which is long lasting and does not require frequent relearning of a new paintbrush handles.

### SUMMARY OF THE INVENTION

In one aspect, the present invention is a paintbrush handle comprising an axially elongated handle having a pair of ends, at least one end having means for attaching a brush tip, wherein the handle is composed a durable material.

In another aspect, the present invention is a process for striping an automobile comprising applying to a painted automobile a decorative stripe using a paintbrush having a paintbrush handle comprising an axially elongated handle having a pair of ends, at least one end having means for attaching a brush tip, wherein the handle is composed a durable material.

### BRIEF DESCRIPTION OF THE DRAWINGS

For a detailed understanding of the present invention, reference should be made to the following detailed description of the preferred embodiments, taken in conjunction with the accompanying drawings, in which like elements have been given like numerals, wherein:

FIG. 1 is a perspective view of a paintbrush handle of the present invention.

FIG. 2 is a perspective view of a paintbrush tip of the present invention.

It will be appreciated that the drawings are not necessarily to scale and certain features have been exaggerated to show detail.

### DETAILED DESCRIPTION OF THE PREFERRED EMBODIMENT

In one embodiment, the present invention is a reusable paintbrush handle composed of a durable material. Preparing a reusable paintbrush handle from a durable material is an important improvement over the prior art. One overlooked element in designing and manufacturing paintbrush handles is the need for such handles that can be used for a very long time without wearing out.

In some specialized applications, it is necessary for one using a paintbrush to be able to make very long, fine lines. While much effort has been put into designing tips for these applications, such as in U.S. Pat. No. 5,220,702 to Howell, less thought has been given to the handle. While a paintbrush handle must be of a size and shape generally appropriate to the application in which it will be used, there is an additional element in the art of painting such lines that is not apparent to one of ordinary skill in such applications. When an artisan who makes such lines wears out or otherwise has to replace a brush, the artisan must learn the new brush before he can be efficient in using it.

For purposes of the present invention, the term learning a brush means the process whereby an artisan becoming sufficiently familiar with the brush handle so that the artisan can use it with the same accuracy and speed as, for example, a familiar brush discarded due to wear. The time to learn a brush handle naturally varies with the application and artisan, but it can be very significant in certain applications. For example, automobile striping is a very exacting application where the time necessary to learn a new brush handle can be very significant.

In the art of striping an automobile, also known as detailing, an artisan applies paint to an automobile. In conventional automobile manufacturing, painting is an expensive process with the paint being applied to automobiles costing as much as $1,000.00 per gallon or more. After an automobile has been primed and painted to a desired color, in almost all cases a final coat of paint, typically referred to as a clearcoat, will be applied which does not itself contain a pigment, but is intend to both improve the appearance of the paints underneath it as well as provide some measure of protection against corrosion and other hazards.

In automobile striping, an artisan applies paint to the clearcoat of an automobile. While there is often some design, lettering, or picture applied, most commonly the process includes the application of very long narrow lines of paint applied along edges and ridges of the automobile body that are, by design, highly conspicuous. Depending upon the automobile to be striped, these lines can be as narrow as 2 mm and as long as 5 meters. As these lines are typically drawn essentially without the use of mechanical guides, having precise control of the brush handle being used is very important.

One reason that it is important to be able to control a brush handle being used in an application such as automobile striping is the consequences when such control is not maintained. A 2 mm line being applied for as much as 5 meters can show even very small inconsistencies in width and straightness. Such inconsistencies in an esthetic application can be unacceptable to purchasers of such services that can require the removal and reapplication of the striping. Naturally, the time and expense of removal of paint from an automobile can be very expensive, particularly if it requires the application of a new clearcoat. The costs of lost productivity to learn a new brush handle can also be significant in what is a very competitive environment.

To reduce the number of times that an artisan must relearn a brush handle, the brush handles of the present invention are made of durable materials. For purposes of the present invention, a durable material is one that can withstand repeated use and cleaning on a daily basis. For example, a brush handle of the present invention can preferably be used daily for one hour and then cleaned using commonly available cleaning solvents for at least two years, more preferably five years, and most preferably ten years without wearing to the point that the brush handle must be replaced or relearned by the artisan using it.

The durable materials used to prepare the brush handles of the present invention include a material selected from the group consisting of a metal, a durable plastic, a stone material, a bone material, and a hardwood. When metals are used to prepare the brush handles of the present invention, preferably the metal is selected from the group consisting of aluminum, steel, and bronze, but any metal or metal alloy can be used as long as it meets the wear criteria of the present invention. When plastics are used, they are preferably machineable thermoset plastics that are capable of withstanding the effects of cleaning solvents. When wood is used, it is preferably a hardwood. As with the metals, any durable material, plastic, wood, or other, can be use with the present invention as long as it can meet the war criteria set out above.

The brush handles useful with the present invention are primarily intended for applications wherein drawing very long and vary narrow lines is done. For example, a brush handle of the present invention would not typically be used to do non-artistic work such as painting a house. Preferably, the brush handles are comparatively short. Abrush handle of the present invention is from about 1 to 9 inches long. More preferably, a brush handle of the present invention is from about 3 to 8 inches long. Most preferably, a brush handle of he present invention is from about 4 to 8 inches long.

The paintbrush handles of the present invention are preferably narrow. For example the paintbrush handles of the present invention preferably have a width of from about one eighth (⅛) inch to about one and half (1½) inches. More preferably, the paintbrush handles of the present invention preferably have a width of from about one quarter (¼) inch to about one (1) inch. Most preferably, the paintbrush handles of the present invention have a width of from about one quarter (¼) inch to about one half (½) inch.

Brush handles of the present invention can be of almost any shape that is conducive to its use in its intended application. In one embodiment of the present invention, the paintbrush handle is a custom made handle manufactured according to specification set out by its intended user. Criteria used in the selection of brush handle shapes are a function of the brush handle's intended use and the dimensions and of the intended user's hand.

Brush tips useful with the present invention are preferably ferrules that have fibers at one end and a means of attaching to the brush handle at the other. They type of fibers which can be used with the present invention varies according to the application to which the brush tip will be put to use and the personal preference of the user. By their very nature, fibers wear out and need to be replaced and it is an object of the present invention that use of a long lasting brush handle minimize or eliminate the relearn time associated with replacing worn or damaged brushes.

Paintbrush tips can be attached to the paintbrush handles of the present invention by any means known to those of ordinary skill in the art of manufacturing paintbrushes. For example, one means of attaching tips to the paintbrush handles is by having a the tip with an internally threaded receptacle and a paintbrush tip having a male threaded member such that the male member can be screwed into the receptacle joining the two together. In another means, the male member is on the tip and receptacle is on the brush handle. Other types of clamps, connectors and the like can also be used with the present invention. When preparing the brush handles and paintbrush tips of the present invention, preferably, the materials selected are such that if, for example, a thread is stripped, it is the tip and not the paintbrush handle that has the stripped connector and needs to be replaced.

While automobiles are, by far, the most commonly striped objects, other objects are sometimes also striped. For example, objects that are also occasionally striped include boats, safes, antique refrigerators, trailers, recreational vehicles, and the like. For purposes of the present invention, the term automobile also includes other detailed objects.

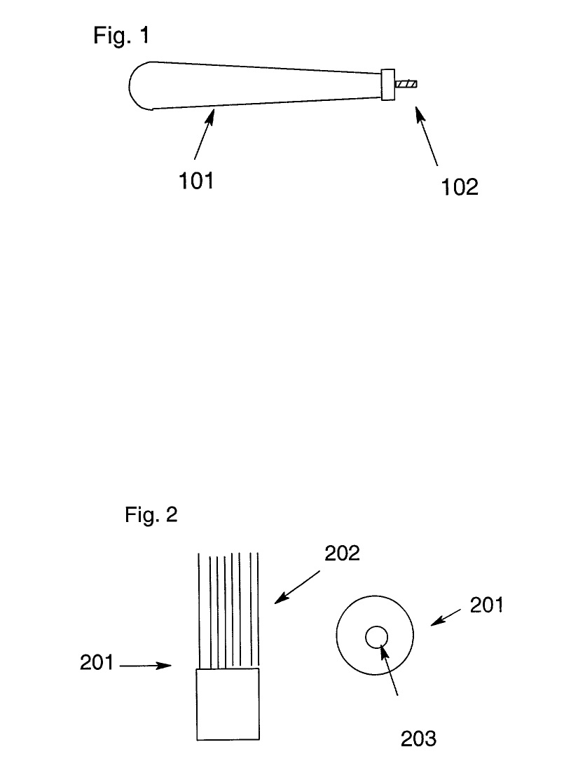

FIG. 1 is a perspective view of a paintbrush handle of the present invention. The paintbrush handle of the present invention (101) includes, in this embodiment, a means of attaching a tip that is a male screw member (102).

FIG. 2 is a perspective view of a paintbrush tip of the present invention. The paintbrush tip (201) includes fibers (202) and a screw receptacle (203) on the side of the ferule opposite from the fibers for receiving the male member of the paintbrush handle (102).

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the inventions and should not be construed to limit scope of the claims thereof.

What is claimed is:

1. A paintbrush handle comprising an axially elongated handle having a pair of ends, at least one end having means for attaching a brush tip, wherein the handle is composed a durable material.

2. The handle of claim 1 wherein the durable material is selected from the group consisting of a metal, a durable plastic, and a hardwood.

3. The handle of claim 2 wherein the metal is selected from the group consisting of aluminum, steel, and bronze.

4. The handle of claim 1 wherein the handle has width of from about one eighth (⅛) inch to about one and a half (1½) inches and a length of from about one (1) inch to about nine (9) inches.

5. The handle of claim 4 wherein the handle has width of from about one quarter (¼) inch to about one (1) inch and a length of from about three (3) inches to about eight (8) inches.

6. The handle of claim 5 wherein the handle has width of from about one quarter (¼) inch to about one half (½) inch and a length of from about four (4) inches to about eight (8) inches.

7. The paintbrush handle of claim 1 wherein the means for attaching the tip is an internally threaded receptacle.

8. The paintbrush handle of claim 7 additionally comprising a tip consisting of a ferrule having, at a first end, a set of fibers, and at a second end, a threaded member sized to be screwed into the internally threaded receptacle.

9. The paintbrush of claim 1 wherein the means for attaching the tip is a threaded member.

10. The paintbrush of claim 9 additionally comprising a tip consisting of a ferrule having, at a first end, a set of fibers, and at a second end, a threaded receptacle sized to accept the threaded member.

11. A process for striping an automobile comprising applying to a painted automobile a decorative stripe using a paintbrush having a handle of claim 1.

12. The process of claim 11 additionally comprising replacing worn paintbrush tips as they wear out.
